(19) United States
(12) Patent Application Publication
(10) Pub. No.: US 2006/0204725 A1
(43) Pub. Date: Sep. 14, 2006

(54) Polyolefin closure strip and method for making

(76) Inventors: Mark Pavlansky, Elkin, NC (US); Keith Pavlansky, Yadkinville, NC (US)

Correspondence Address: Charles Y. Lackey, PO Box 5871, Winston-Salem, NC, 27113-5871, US

(21) Appl. No.: 11/076,495

(22) Filed: Mar. 10, 2005

(51) Int. Cl. B29C 44/20

(52) U.S. Cl. 428/174; 264/45.9; 264/151; 156/78; 428/158

(57) ABSTRACT

A process for forming roof closure members in a selective design. A supply of polyolefin plastic is extruded foamed and moved to rotary die press where it is cut to form a continuous supply of roof closure members. This application also includes a closure member formed by the process.

### BACKGROUND OF THE INVENTION

1. Field of the Invention

The present invention relates to a metal roof construction polyolefin gap and void filler which keeps excess water, insects, birds, small animals and other foreign contaminants out of a roofing system as the filler forms a seal.

2. Description of the Prior Art

Rising construction costs have been a continued challenge facing the building industry. Metal buildings and metal roofing have provided a very efficient alternative for construction projects and continue to proliferate in new construction projects and expansion projects in existing facilities. Roof profiles for such projects typically have gaps and voids because of the roof support structure. When the gaps are ignored, birds and small animals can enter the building through these openings. These gaps and voids must be filled to have an effective roof system. Materials used to close these gaps and voids are known as closure strips.

Historically, rubber materials including EPDM and vinyl nitrate were used in the construction of metal buildings and roofs to prevent water and insects from penetrating the joints of the buildings. In the 1970's, it was discovered that polyethylene foam could perform as well as EPDM and vinyl nitrate products. It worked well because it was closed cell and light (2 pounds per cubic foot), but it suffered oxidation and premature aging problems. The preferred material in the industry became crosslinked polyethylene which did not have the oxidation problem of linear polyethylene. A major disadvantage of crosslinked material was its limited availability from manufacturers. Requirements in other markets often limited the availability of crosslinked material in the metal building markets.

New products for the metal building market were sought. The physical shortcomings of crosslinked material were identified as (a) the material was non-recyclable, (b) it had no ultraviolet stabilizer which would help to extend the life of the product, (c) the original crosslinked material had no fire retardant properties and (d) the crosslinked product had substantial shrinkage problems at elevated temperatures which allowed the ready passage of rain water and insects. Typical metal roof temperatures during the warmer months can reach from 180 to 200 degrees F.

Other products were developed that improved the product to some extent, but the low level of thermal stability remained a problem since such products shrink at high temperature levels. Thus is was critical that a more stable material be found to have ultraviolet stability, recyclability, compressive strength, fire retardancy, tear resistance and thermal stability at high temperatures without shrinkage. It is to that critical requirement that the present invention is directed.

Thus there has been outlined the more important features of the invention in order that the detailed description that follows may be better understood and in order that the present contribution to the art may be better appreciated. There are, of course, additional features of the invention that will be described hereinafter and which will form the subject matter of the claims appended hereto. In that respect, before explaining at least one embodiment of the invention in detail, it is to be understood that the invention is not limited in its arrangement of the components set forth in the following description and illustrated in the drawings. The invention is capable of other embodiments and of being practiced and carried out in various ways.

It is also to be understood that the phraseology and terminology employed herein are for the purpose of description and should not be regarded as limiting in any respect. Those skilled in the art will appreciate that the concept upon which this disclosure is based may readily be utilized as a basis for designing other structures, methods and systems for carrying out the several purposes of this development. It is important that the claims be regarded as including such equivalent methods and products resulting therefrom that do not depart from the spirit and scope of the present invention. The application is neither intended to define the invention of the application, which is measured by its claims, nor to limit its scope in any way.

Thus, the objectives of the invention set forth above, along with the various features of novelty which characterize the invention, are noted with particularity in the claims annexed to and forming a part of this disclosure. For a better understanding of the invention, its operating advantages and the specific results obtained by its use, reference should be made to the following detailed specification taken in conjunction with the accompanying drawings wherein like characters of reference designate like parts throughout the several views.

The drawings are included to provide a further understanding of the invention and are incorporated in and constitute a part of this specification. They illustrate embodiments of the invention and, together with their description, serve to explain the principles of the invention.

### OBJECTIVES AND SUMMARY OF THE INVENTION

A primary objective of the present invention is to develop a material that will function as a closure strip that has all of the benefits of prior art materials, and more, and none of the disadvantages.

Another objective of the present invention is to develop a process that would enable the extruded closure material to be incorporated in and combined with the cutting process to enable significant increased production of closure strips.

Yet another objective of the present invention is to develop a process that will enable increased efficiencies by reducing direct labor and eliminating substantially all waste raw material in the production of closure strips.

Still another objective of the present invention is to develop a process for cutting varying lengths of closure members.

In summary, the present invention is a process for forming roof closure members wherein a continuous supply of polyolefin plastic is extruded, foamed and introduced to a rotary die press where it is cut to form a continuous supply of roof closure members having a preselected roof profile design. In another embodiment, the process includes forming a polyolefin sheet by laminating a number of thinner sheets and die cutting the laminated foamed sheet to form defined closure members. The invention also includes a closure member with specific performance characteristics and the polyolefin plastic is polypropylene.

### BRIEF DESCRIPTION OF THE DRAWINGS

FIG. 1 is a perspective view of the rotary die press and the continuously extruded and foamed closure strip moving through and cut by the die press all forming a part of the present invention.

FIG. 2 is a top plan view of the die press and closure strip shown in FIG. 1.

FIG. 3 is a side elevational view of the die press and closure strip shown in FIGS. 1 and 2.

FIG. 4 is a perspective and partial view of closure member to which a bead of adhesive has been applied.

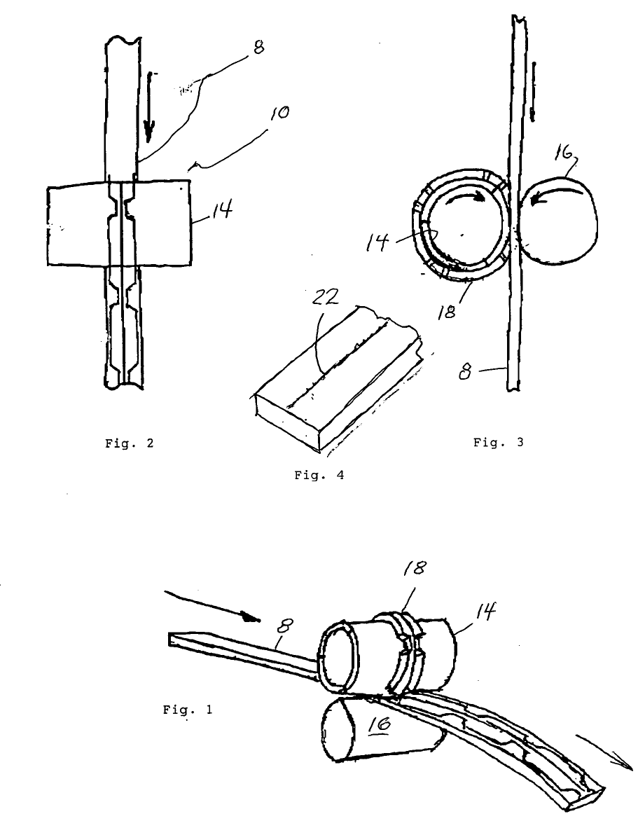

### DETAILED DESCRIPTION OF THE PREFERRED EMBODIMENT

The present invention is directed to a polyolefin plastic (“PP”) profile that is cut to match the contour of each building's roof surface profile. The PP is foamed and the PP foamed plastic is thermally stable at high temperatures (around 200 degrees F.) commonly occurring in roof applications and forms a barrier that prevents excess water, air and vermin from entering the building. The consistent availability of PP foamed plastic strips (closure strips) ensures a more reliable source of supply which was always questionable with both domestic and foreign suppliers. PP closure strips provide an economic advantage with raw material cost savings over the currently used XLPE material. Moreover, PP foamed plastic is substantially ten (10) times more stable than XLPE material when both are subjected to the same aging conditions.

In the present invention, an in-line cutting process commences with the extrusion and foamation of PP into a continuous strip which is approximately 1 inch thick by 4 inches wide and shown generally as 8. The material 8, in this example polypropylene, is cooled uniformly and then introduced into a rotary die press shown generally as 10 which is synchronized to have its cylindrical drums 14, 16 running at the same speed as the extruded foam 8. One of the cylindrical drums 14 is fitted with a rotary die cutting tool 18 that will cut extruded foam strip 8 to the desired configuration. Rotary die cutting tool 18 can be removed and stored, and any of a number of differently configured die cutting tools may be installed. Once the desired quantity of closure strips is attained for any tool 18, another die cutting tool is installed and a subsequent order is filled.

Traditionally, all manufacturing of closure strips has been conducted on standard kiss cut hydraulic die presses. This is not a completely efficient operation since they are cut from 1 inch by 60 inch by 10 inch sheets of raw material with the length of each formed closure strip being 36 inches. The size of the sheets limited the efficient formation of the closure strips, and some loss of raw material always occurred. On the rotary press of the present invention, the 1 inch by 3 inch by unlimited length substantially eliminates raw material waste and substantially increases the amount of closure strips being cut. Using press 10 enables the provision of continuous strips or the traditional 36 inch strip, whatever a customer might request.

Additional efficiencies result from the way closure members are formed as the PP foam material is continuously cut by press 10. The design of the closure strip enables 2 continuous strips to be formed at the same time. See FIG. 2. Rotary die press 10 cuts the continuous 1 inch by 4 inch down the center to form 2 continuous strips approximately 1 inch high by 2 inch wide while during the same cutting operation each closure strip is cut to the desired profile. All formed closure strips are identical.

Many closure strips are supplied to customers with an applied adhesive bead 22. See FIG. 4. The adhesive bead permits the closure strips to be positioned on and affixed to the metal roof. The application of the adhesive bead to the continuous closure strip is incorporated in the “in-line” process of the present invention.

The closure strips formed hereunder may be treated with a fire retardant additive in the extrusion and foaming process or coated with such an additive after the closure members are formed. An ultraviolet inhibiting additive which enhances the closure member lifespan may also be incorporated in the “in-line” process or applied to the finished closure members in the same manner.

From the proceeding description, it can be seen that a seed applying flow apparatus been provided that will meet all of the advantages of prior art devices and offer additional advantages not heretofore achievable. With respect to the foregoing invention, the optimum dimensional relationship to the parts of the invention including variations in size, materials, shape, form, function, and manner of operation, use and assembly are deemed readily apparent to those skilled in the art, and all equivalent relationships illustrated in the drawings and described in the specification are intended to be encompassed herein.

The foregoing is considered as illustrative only of the principles of the invention. Numerous modifications and changes will readily occur to those skilled in the art, and it is not desired to limit the invention to the exact construction and operation shown and described. All suitable modifications and equivalents that fall within the scope of the appended claims are deemed within the present inventive concept.

What is claimed is:

1. A process for forming roof closure members comprising the steps: of: foaming and extruding a continuous supply of polyolefin plastic; directing the extruded polyolefin plastic to a rotary die press; cutting the engaged polyolefin plastic to form a continuous supply of roof closure members of a preselected profile design; and collecting the supply of roof closure members for subsequent storage or shipping.

2. The process as claimed in claim 1 wherein the formed roof closure members are cut into separated strips of a predetermined length.

3. The process as claimed in claim 1 wherein the collected roof closure members are positioned in a continuous roll of connected closure members.

4. The process as claimed in claim 1 wherein a continuous bead of adhesive material is placed on a selected surface of the formed closure members.

5. The process as claimed in claim 2 wherein a continuous bead of adhesive material is placed on a selected surface of the formed closure members.

6. The process as claimed in claim 3 wherein a continuous bead of adhesive material is placed on a selected surface of the formed closure members.

7. The process as claimed in claim 1 wherein the polyolefin plastic is polypropylene foam.

8. The process as claimed in claim 1 wherein the polyolefin plastic is polyethylene foam.

9. The process as claimed in claim 1 wherein the extruded foam has a width of up to 12 inches and a height of up to one inch.

10. The process as claimed in claim 2 wherein the extruded foam has a width of up to 12 inches and a height of up to one inch.

11. The process as claimed in claim 3 wherein the extruded foam has a width of up to 12 inches and a height of up to one inch.

12. The process as claimed in claim 1 wherein the extruded foam is cooled uniformly before being directed to the rotary die press.

13. The process as claimed in claim 2 wherein the extruded foam is cooled uniformly before being directed to the rotary die press.

14. The process as claimed in claim 3 wherein the extruded foam is cooled uniformly before being directed to the rotary die press.

15. The process as claimed in claim 1 wherein the formed closure members are fire retardant.

16. The process as claimed in claim 1 wherein the formed closure members are ultraviolet resistant.

17. The process as claimed in claim 1 wherein the extruded foam is recyclable.

18. A metal building closure strip comprising: an elongated polypropylene body portion having a roof-engaging portion and a building-engaging portion, the body portion having a linear shrinkage of less than 5%, an elongation rating of less than 25%, a compression set rating within the range of from 12% to 20%, a water absorption rating of less than 0.04 pounds per square foot, a tear resistance rating of more than 6.0 pounds per inch, an ultra violet resistance rating of more than 3000 hours, an upper service temperature rating of 280 degrees F. and a lower service temperature rating of −100 degrees F.

19. A process for making sheets of material for forming roof closure members comprising the steps of: placing a polyolefin plastic sheet within a confined and closed area on a substantially level supporting surface; foaming the polyolefin sheet; laminating the foamed polyolefin sheet with additional polyolefin sheets to increase the thickness of the foamed laminated polyolefin laminated sheet from 3 to 5 times; cooling the confined quantity of the foamed laminated polyolefin sheet uniformly; die cutting the confined cooled and laminated foamed polyolefin sheet to form defined closure members for subsequent use, storage, or shipment.

20. Metal building closure member material comprising: a polyolefin body portion having a top roof-engaging surface and a bottom building engaging surface, the body portion having a linear shrinkage of less than 5%, an elongation rating of less than 25%, a compression set rating within the range of from 12% to 20%, a water absorption rating of less than 0.04 pounds per square foot, a tear resistance rating of more than 6.0 pounds per inch, an ultra violet resistance rating of more than 3000 hours, an upper service temperature rating of 280 degrees F. and a lower service temperature rating of −100 degrees F.

22. The material as claimed in claim 21 wherein the polyolefin plastic sheet is polypropylene.

23. The material as claimed in claim 19 wherein the polyolefin material is polypropylene.
